(19) United States
(12) Patent Application Publication
(10) Pub. No.: US 2009/0067905 A1
(43) Pub. Date: Mar. 12, 2009

(54) Document management system and method

(75) Inventors: Peter Stanley Fisher, (US); Kip Jungle, (US); William Fancher, (US)

Correspondence Address: ORTIZ & LOPEZ, PLLC, P. O. BOX 4484, ALBUQUERQUE, NM, 87196-4484, US

(73) Assignee: Xerox Corporation

(21) Appl. No.: 11/900,458

(22) Filed: Sep. 12, 2007

(51) Int. Cl. G03G 15/00; G03G 21/00

(52) U.S. Cl. 399/361; 270/1.01

(57) ABSTRACT

An improved system and method for tracking and managing documents in a high throughput document printing line comprising a printing means, a sensor means and a processing means. The printing means prints a desired invisible symbology and visible text on a document fed to it. The clear printing toner is fused with an invisible marker. The invisible symbology is printed on the document using the invisible marker. The sensor means is capable of reading the invisible symbology printed on the document. The sensor means communicates the sensor readings to a processing means. The processing means receives the sensor readings from the sensor means and correlates the sensor readings with data identifying a plurality of projects thereby determining the appropriate project to which the printed document belongs.

### FIELD OF THE INVENTION

The present invention relates to an improved method for tracking and managing documents. More particularly, the present invention relates to an improved method for tracking and managing documents in a high throughput document production unit.

### BACKGROUND OF THE INVENTION

In a high throughput document production unit, there is a need in the art to inspect and identify each document being produced in a reliable and efficient manner before it is processed further. It has been seen that the introduction of a document inspection and identification system within a high throughput printing line almost always compromises the output capacity of the printing line. However, these inspection and identification systems are nevertheless required to maintain the integrity of the final product.

In high throughput production units whether simultaneous printing is carried out over different printers or where printing jobs belonging to two different projects are carried out on the same single high capacity printer, it becomes essential to identify the project to which a particular printed document belongs and to classify and process the same accordingly. Furthermore, it is often required to subject a document to a plurality of successive printing passes through a plurality of successive printers wherein the first printer is assigned to print a predetermined first subject matter and the next successive printer is assigned to print a predetermined second subject matter in the succeeding pass on the same page either on the same side as the previous print or on the opposite face. In particular cases, the successive printing devices are each fed with printing inks having different shades.

In such high throughput systems, it becomes all the more essential to properly identify a printed document and to classify and feed it appropriately to the succeeding printing passes.

The printing process requires efficient document identification and management systems in such distributed infrastructure comprising high throughput printing production units. It is necessary to manage the entire printing line from the creation of the digital documents, printing those documents, properly identifying and classifying the printed documents, finishing and delivering the project in a reliable manner to maintain the integrity of the project. The product integrity may be compromised even if one error or mismatch creeps in at any stage of the printing line.

For example, it is a common practice at publication houses to print the book cover and the inside pages at different printers at different times. These randomly printed cover and inside pages are thereafter sent to the finishing line and subjected to an automated binding step, where a problem of mismatch of the cover and the inside pages is frequently encountered.

The conventional practice followed in the art to overcome these problems in the finishing line is to simultaneously print a machine readable barcode or other symbology on the printed documents to enable their identification and classification. However, the barcodes and other symbologies displayed on the printed documents to help their identification and proper classification suffer from several disadvantages.

The barcodes and other symbologies are obtrusive and decrease the documents aesthetics. Further, there needs to be reserved a clear zone within the document for displaying such barcodes and other symbologies, which need to be accommodated within the limited space available on a document.

It has further been seen that within a document, the barcodes tend to be printed towards the edge of the document containing full lines of text such that the resulting barcodes become unreadable by the machine resulting in further errors creeping in within the document production line.

To overcome these problems existing within the art, it has been suggested to display barcodes and other symbologies on the printed document that are invisible to the human eye but are capable of being read by an appropriate sensor provided on a barcode reading machine.

These invisible barcodes and other symbologies are capable of being printed over the text, which eliminates the need to reserve a separate zone on the printed document. This is further advantageous in that the invisible barcodes can be printed along with the document content in the same printer pass. In these applications, a separate inkjet head is mounted within the printer with an ink reservoir mounted behind it for supplying the invisible ink to the invisible inkjet head. This system typically comprises an illuminator which renders the invisible ink fluorescent and a camera for read-after-write validation, identification and subsequent classification of the printed document.

Although, the described system can solve some of the problems existing within the art, is not currently used in the art due to its inherent deficiencies. The implementation of such invisible barcode system is expensive due to the high cost of the UV/IR readable invisible ink. It was further found that the invisible ink did not dry fast enough leading to the problems of machine contamination and associated problems.

There exists a need in the art for an improved document tracking and management system and method in almost every walk of life. For example, hospitals, health service institutions, insurance companies can keep track of medical records of particular persons. Likewise, the banks, financial institutions, attorneys, courts, accountants, manufacturers and other government agencies may keep track of loan files, client files, personal files, case files and evidences in a speedy and accurate manner using the system and method for document tracking and management.

Thus, there exists a need in the art for an improved method for tracking and managing documents in a high throughput document production unit that is economical, reliable and which does not lead to a combination of the printing machine.

### SUMMARY OF THE INVENTION

Accordingly, it is an object of the present invention to provide an improved method and system for tracking and managing documents in a high throughput document production unit that is economical, reliable and which does not lead to a contamination of the printing machine.

Yet another object of the present invention is to provide an improved method and system for tracking and managing documents in a high throughput document production unit that is capable of reliable document verification for maintenance of project integrity.

It is yet another object of the present invention to provide an improved method and system for tracking and managing documents in a high throughput document printing line that is capable of a reliable and efficient inspection and identification of each document being printed without compromising the output capacity of the printing line.

Accordingly, in one aspect, the present invention provides an improved system for tracking and managing documents in a high throughput document printing line comprising a printing means, a sensor means and a processing means. The printing means is capable of simultaneously printing a desired invisible symbology and visible text on a document fed to it. The printing means is further provided with a clear printing toner fused with an invisible marker wherein the invisible symbology is printed on the document using the invisible marker. The sensor means is capable of reading the invisible symbology printed on the document. The sensor means communicates the sensor readings to a subsequent processing means. The processing means receives the sensor readings from the sensor means and correlates the sensor readings with data identifying a plurality of projects thereby determining the appropriate project to which the printed document belongs.

In another aspect, the present invention provides an improved method for tracking and managing documents in a high throughput document printing line comprising printing an invisible symbology on a document, reading the invisible symbology at a different location and correlating the reading with data identifying a plurality of projects. The method of the invention comprises providing a printing means capable of simultaneously printing a desired invisible symbology and visible text on a document with a clear printer toner fused with an invisible marker. The invisible marker is used to print an invisible symbology on the document. The invisible symbology printed on a document is read using a sensor means capable of reading such invisible symbologies. The sensor readings are thereafter communicated to a processing means. The sensor readings are correlated with data identifying a plurality of projects within the processing means thereby determining the appropriate project to which said printed document belongs.

### BRIEF DESCRIPTION OF THE DRAWINGS

The invention will now be described in connection with the drawing described hereinafter.

FIG. 1 illustrates a system for tracking and managing documents in a high throughput document printing line.

FIG. 2 illustrates a method for tracking and managing documents in a high throughput document printing line.

### DETAILED DESCRIPTION OF THE INVENTION

In accordance with an exemplary aspect of the invention, there is provided an improved system for tracking and managing documents in a high throughput document printing line comprising: a printing means that is capable of simultaneously printing a desired invisible symbology and visible text on a document fed to said printing means, said printing means being provided with a clear printing toner fused with an invisible marker wherein said invisible symbology is printed on said document using said invisible marker; a sensor means capable of reading said invisible symbology printed on a document and communicating the sensor readings to a processing means; and a processing means capable of receiving the sensor readings from the sensor means and correlating said sensor readings with data identifying a plurality of projects to determine the appropriate project to which the printed document belongs.

In accordance with another exemplary aspect, the present invention provides an improved method for tracking and managing documents in a high throughput document printing line comprising: providing a printing means capable of simultaneously printing a desired invisible symbology and visible text on a document with a clear printer toner fused with an invisible marker, said invisible marker being used to print said invisible symbology on said document; reading said invisible symbology printed on a document using a sensor means capable of reading such invisible symbologies and communicating the sensor readings to a processing means; and correlating said sensor readings fed to a processing means with data identifying a plurality of projects thereby determining the appropriate project to which said printed document belongs.

In a preferred embodiment, the printing means comprises a printing head which includes a printing cartridge. The printing cartridge conventionally used in the printing system art contains printing toners which contains an invisible marker. In conventional printing systems known in the art, the invisible marker is used for internal printing control but has never been used for document tracking and management.

The present invention is based on the finding that when said invisible marker is used to print a near invisible symbology (invisible symbology) using conventional toner on the printed document, the said invisible symbology can be reliably read using a sensor means adapted to read such invisible symbology. This approach of printing the invisible symbology using the invisible marker already present in a printing toner avoids the problem of machine contamination because the invisible symbology dries at least as fast as the printed text thereby ruling out any possibility of machine contamination. It has also been found that this approach does not increase the overall cost and efficiency of the document tracking and management system.

In a preferred embodiment, the invisible marker present within the printing toner is an infrared marker, which prints an infrared visible symbology on the printed document.

In another preferred embodiment, the sensor means is a camera that is capable of reading the invisible symbology printed on a document.

In yet another preferred embodiment, the sensor means is an infrared sensing scanner that is capable of reading an infrared symbology printed on a document, or an IR sensor.

In yet another preferred embodiment, the sensor means is an infrared sensing camera that is capable of reading an infrared symbology printed on a document, or is an IR camera.

The processing means, which can be provided in the form of a computer resource typically installed in most printing or data processing systems, receives the sensor readings, preferably the infrared sensor readings from the sensor means, preferably the infrared sensing scanner. The processing system thereafter processes the image received from the infrared sensing camera or decodes the infrared barcode using an image processing system and a barcode decoding system. The processing means stores data identifying a plurality of projects operational in the document tracking and management system of the invention. The image or the barcode sensed by the sensing means is correlated with the stored data identifying a plurality of objects to determine the project to which the identified document belongs.

The processing means correlates the infrared sensor readings received from the sensor readings with the data identifying a plurality of projects and determines the project to which a document belongs. The tracked documents are thereafter routed to the project location from where the identified project is controlled and delivered.

In a further preferred embodiment, the printing means receives the print data stream from a data source such as a computer through a data network. The data network may be a local area network or a wide area network such as internet. The wide area networking between the data source computer and the printing means enables the document tracking and management to be performed from a remote location such as over the internet.

In a preferred embodiment, the invisible symbology printed on a document is an infrared barcode. In this embodiment, the infrared barcode is read by an infrared sensor means, which may preferably be an infrared laser bar code scanner.

In a further preferred embodiment, the processing means stores the data identifying a plurality of projects in the form of a database. The processing means, upon receipt of the sensor readings from the sensing means, correlates the readings with the database elements to identify the project to which the printed document belongs.

In a further preferred embodiment, the database may further include data identifying the location of a particular project to which an identified document is sent, the project numbers and other project identifiers and other statistical data.

In a preferred embodiment, the invisible infrared barcode represents project number to which the document belongs which is tallied with the plurality of project numbers stored in the processing means database to determine the relevant project.

In another preferred embodiment, the invisible infrared barcode scanner is a high speed laser barcode scanner which is capable of scanning a one-dimensional barcode as well as a two-dimensional barcode.

In another embodiment, the invisible symbology printed on the document may be a predetermined character which may be tallied with another predetermined character stored in the database to identify a printed document.

In another embodiment, the invisible symbology printed on the document may be predetermined logo, which may be visualized with a sensor means being a camera. In this embodiment, the predetermined logo may be compared with a predetermined pattern stored within the database to identify a document.

In another embodiment, the disclosed system for tracking and managing documents further comprises a dispatch system which inserts an identified document belonging to a predetermined project into an envelope having an address displayed thereon, said displayed address being the location of the determined project.

In another embodiment, the disclosed method for tracking and managing documents further comprises inserting a document identified as belonging to a predetermined project into an envelope having an address displayed thereon, said displayed address being the known location of the determined project.

In a preferred embodiment, the identified document is inserted within a target envelope using conventional insertion equipments such as those available from well known companies such as Pitney Bowes, Böwe Bell and Howell or Gunther International.

The toners found suitable for use in the methods and systems for tracking and managing documents described herein may be a conventional clear toner comprising a polymeric resin, a charge control agents or any type/amount of external or internal additives that are required to properly develop the toner to the media substrate. The toner essentially comprises an invisible marker, which is preferably an infrared marker. The toner can be made by the Emulsion Aggregation (EA) (chemical toner) process or conventional ground toner process.

In a preferred embodiment, the clear toner found most suitable for use in the method and system described herein is commercially available from Xerox Corporation. This clear toner comprises an infrared marker, which is found most suitable for use in the method and system according to the present invention.

In a further preferred embodiment, the average particle size of the toner found suitable for use in the present invention ranges from about 5 to 30 microns, though higher toner qualities having lower particle sizes are not excluded.

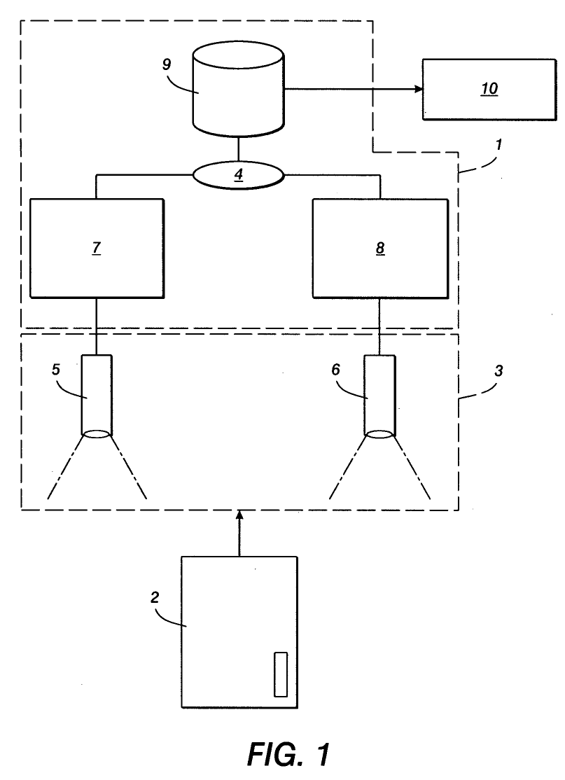

Referring to FIG. 1, illustrated is a system 1 for tracking and managing documents in a high throughput document 2 printing line comprising a printing means (not shown), a sensor means 3 and a processing means 4. The printing means is capable of simultaneously printing a desired invisible symbology and visible text on a document fed to it. The printing means is further provided with a clear printing toner fused with an invisible marker wherein the invisible symbology is printed on the document using the invisible marker. The sensor means is capable of reading the invisible symbology printed on the document. The printing means may be an infrared sensing camera 5 or an infrared sensing sensor 6. The sensor means communicates the sensor readings to a subsequent processing means. The processing means receives the sensor readings from the sensor means. The processing system thereafter processes the image received from the infrared sensing camera or decodes the infrared barcode using an image processing system 7 and a barcode decoding system 8. The processing means stores data identifying a plurality of projects operational in the document tracking and management system of the invention in a database 9 provided within the processing system. The image or the barcode sensed by the sensing means is correlated with the stored data identifying a plurality of objects to determine the project to which the identified document belongs, which is thereafter forwarded to the dispatch means 10.

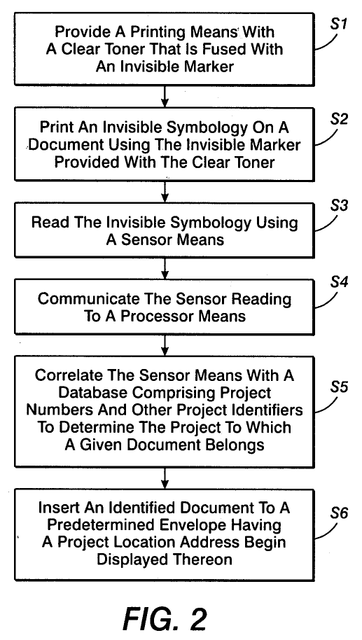

Referring to FIG. 2, illustrated is a flowchart illustrating an improved method for tracking and managing documents according to an embodiment of the present invention comprising printing an invisible symbology on a document, reading the invisible symbology at a different location and correlating the reading with data identifying a plurality of projects. The method of the invention comprises providing a printing means capable of simultaneously printing a desired invisible symbology and visible text on a document with a clear printer toner fused with an invisible marker as shown in step 1 (S1). The invisible marker is used to print an invisible symbology on the document as shown in step 2 (S2). The invisible symbology printed on a document is read using a sensor means capable of reading such invisible symbologies as shown in step 3 (S3). The sensor readings are thereafter communicated to a processing means as shown in step 4 (S4). The sensor readings are correlated as shown in step 5 (S5) with data identifying a plurality of projects within the processing means thereby determining the appropriate project to which said printed document belongs. The document identified as belonging to a predetermined project is inserted as shown in step 6 (S6) into an envelope having an address displayed thereon, said displayed address being the known location of the determined project.

It is understood that systems, methods, means and other functions described herein may be implemented using software, hardware or its combination. The present invention can also be imbedded into a computer program product, which comprises all the features contained in the methods and systems described herein, and is capable of performing the desired systems and methods when loaded in a computer.

It is further understood that minor modifications may be apparent to a person skilled in the art and all such modifications reasonably and properly fall within the intended scope of the described invention.

What is claimed is:

1. An improved system for tracking and managing documents in a high throughput document printing line comprising:
a printing means that is capable of simultaneously printing a nearly invisible symbology and visible text on a document fed to said printing means, said printing means being provided with a clear printing toner fused with an nearly invisible marker;
a sensor means capable of reading said nearly invisible symbology printed on a document and communicating the sensor readings to a processing means; and
a processing means capable of receiving the sensor readings from the sensor means and correlating said sensor readings with data identifying a plurality of projects to determine the appropriate project to which the printed document belongs.

2. An improved system for tracking and managing documents in a high throughput document printing line as claimed in claim 1, wherein said nearly invisible marker is present within printing toner used by the printing means.

3. An improved system for tracking and managing documents in a high throughput document printing line as claimed in claim 2, wherein said nearly invisible marker is printed as infrared symbology on the document.

4. An improved system for tracking and managing documents in a high throughput document printing line as claimed in claim 1, wherein said sensor means is a camera capable of reading an invisible symbology printed on the document.

5. An improved system for tracking and managing documents in a high throughput document printing line as claimed in claim 1, wherein said sensor means is an infrared sensing scanner capable of reading an infrared symbology printed on the document.

6. An improved system for tracking and managing documents in a high throughput document printing line as claimed in claim 4, wherein said camera is an infrared sensing camera capable of reading an infrared symbology printed on a document.

7. An improved system for tracking and managing documents in a high throughput document printing line as claimed in claim 1, wherein said processing means includes an image processing system which processes the images received from the sensing means.

8. An improved system for tracking and managing documents in a high throughput document printing line as claimed in claim 1, wherein said processing means is adapted to store data identifying a plurality of projects in a database.

9. An improved system for tracking and managing documents in a high throughput document printing line as claimed in claim 8, wherein said database includes data identifying the location of a particular project to which an identified document belongs, the project numbers and other project identifiers and other statistical data.

10. An improved system for tracking and managing documents in a high throughput document printing line as claimed in claim 1, wherein said printing means receives the print data stream from a computer through a data network.

11. An improved system for tracking and managing documents in a high throughput document printing line as claimed in claim 1, wherein said invisible symbology printed on the document is at least one of a predetermined character or logo.

12. An improved method for tracking and managing documents in a high throughput document printing line comprising:
providing a printing means capable of simultaneously printing a desired invisible symbology and visible text on a document with a clear printer toner fused with a near invisible marker, said near invisible marker being used to print said near invisible symbology on said document;
reading said near invisible symbology printed on a document using a sensor means capable of reading such near invisible symbologies and communicating the sensor readings to a processing means; and
correlating said sensor readings fed to a processing means with data identifying a plurality of projects thereby determining the appropriate project to which said printed document belongs.

13. An improved method for tracking and managing documents in a high throughput document printing line as claimed in claim 13, wherein said near invisible marker is readable as an infrared marker by said sensor means.

14. An improved method for tracking and managing documents in a high throughput document printing line as claimed in claim 13 comprising reading a near invisible symbology printed on the document using a sensor means further comprising a camera.

15. An improved method for tracking and managing documents in a high throughput document printing line as claimed in claim 13 comprising reading infrared symbology printed on the document with an infrared sensing scanner.

16. An improved method for tracking and managing documents in a high throughput document printing line as claimed in claim 13 comprising reading an infrared symbology printed on a document with an infrared sensing camera.

17. An improved method for tracking and managing documents in a high throughput document printing line as claimed in claim 13 comprising processing the images received by the sensing means further includes use of an image processing system.

18. An improved method for tracking and managing documents in a high throughput document printing line as claimed in claim 13 comprising communicating the print data stream from a computer to the printing means through a data network.

19. An improved method for tracking and managing documents in a high throughput document printing line as claimed in claim 13, wherein said near invisible symbology printed on the document is at least one of a predetermined character or logo.
